(19) United States
(12) Patent Application Publication
(10) Pub. No.: US 2026/0240139 A1
(43) Pub. Date: Aug. 20, 2026

(54) Trash Bait Station

(71) Applicant: Rafael Farkas, Brooklyn, NY (US)

(72) Inventor: Rafael Farkas, Brooklyn, NY (US)

(21) Appl. No.: 19/536,196

(22) Filed: Feb. 10, 2026

Related U.S. Application Data
(60) Provisional application No. 63/760,277, filed on Feb. 19, 2025.

(51) Int. Cl. A01M 1/20; A01K 97/05; B65F 1/06

(52) U.S. Cl. CPC A01M 1/2011; A01K 97/05; B65F 1/068

(57) ABSTRACT

A trash bait station comprises a receptacle to receive trash. The receptacle comprises an open top closable by a lid, a bottom opposite the open top and a perimeter wall. A bait compartment is associated with the receptacle and to receive a toxic bait that is lethal to rodents. A rodent aperture is in the bait compartment sized to receive a rodent therethrough. A bait aperture is in the bait compartment and configured to allow insertion of the toxic bait into the bait compartment. A bait door is carried by the bait compartment and selectively closes the bait aperture. A partition wall is in the receptacle and forms a substantial enclosure with the perimeter wall to contain the trash, and separates the bait compartment from the substantial enclosure.

### PRIORITY CLAIM

Priority is claimed to U.S. Provisional Patent Application No. 63/760,277, filed Feb. 19, 2025, which is hereby incorporated herein by reference.

### BACKGROUND OF THE INVENTION

### 1. Field of the Invention

This invention relates to a trash bait station for strategically placing toxic bait for rodent control.

### 2. Description of the Related Art

Trash cans can attract rodents that spread disease. Bait stations can be provided around trash cans for rodent control. A bait station is a secure container that can hold a toxic bait while keeping children, pets and non-target animals safe from the accessing the toxic bait. The bait station can have an opening for entry of a rodent to access the bait. In some instances, rodents can ignore bait stations and access trash receptacles directly. The improvement of rodent control is an on-going endeavor.

### BRIEF DESCRIPTIONS OF THE DRAWINGS

With the above and other related objectives in view, the invention consists in the details of construction and combination of parts, as will be more fully understood from the following description, when read in conjunction with the accompanying drawings in which:

FIG. 1 is a front perspective view of an example trash bait station, shown with a lid in a closed position and a bait door in an open position, according to some embodiments.

FIG. 2 is a front perspective view of the example trash bait station of FIG. 1, shown with the bait door is a closed position selectively closing a bait aperture.

FIG. 3 is a rear perspective view of the example trash bait station of FIG. 1.

FIG. 4 is a top perspective view of the example trash bait station of FIG. 1, shown with the lid in an open position.

FIG. 5 is a side view of the example trash bait station of FIG. 1.

FIG. 6 is a top view of an example bottom of the trash bait station of FIG. 1.

FIG. 7 is a side view of the bottom of FIG. 6.

FIG. 8 is a front perspective view of an example trash bait station, shown with a lid in an open position, a bait door or a bait drawer in an open position, and a substantial enclosure in an open position, according to some embodiments.

FIG. 9 is a front perspective view of the example trash bait station of FIG. 8.

### DETAILED DESCRIPTION OF THE EMBODIMENTS OF THE INVENTION

Illustrative embodiments of the present invention are described below. The following explanation provides specific details for a thorough understanding of and enabling description for these embodiments. One skilled in the art will understand that the invention may be practiced without such details. In some instances, well-known structures, processes, and functions have not been shown or described in detail to avoid unnecessarily obscuring the description of the embodiments.

It shall be noted that unless the context clearly requires otherwise, throughout the description, the words “comprise,” “comprising,” “include,” “including,” and the like are to be construed in an inclusive sense as opposed to an exclusive or exhaustive sense; that is to say, in the sense of “including, but not limited to.” Words using the singular or plural number also include the plural or singular number, respectively while adhering to the concepts of the present invention. Furthermore, references to “one embodiment” and “an embodiment” are not intended to be interpreted as excluding the existence of additional embodiments that also incorporate the recited features.

Trash cans can attract rodents, such as rats. Rodents, in turn, can spread disease. Bait stations can be placed near trash receptacles, but rodents can ignore or bypass the bait stations and access the trash receptacles directly.

The present technology presents a trash bait station in which a bait compartment with toxic bait can be part of a trash receptacle. Thus, the rodents attracted by the trash can be drawn to the toxic bait. In some embodiments, the bait compartment can be inside the trash receptacle, but separated from trash. Thus, the toxic bait can be controlled and/or contained in the bait compartment and accessible only to targeted rodents, without being indiscriminately spread to the trash or a larger trash area where it might be accessible to non-targeted rodents. In some embodiments, a bottom of the trash receptacle can be occupied by the bait compartment. A partition wall can separate the bait compartment, and thus the toxic bait, from a substantial enclosure of the receptacle, and thus the trash. A rodent aperture can be formed in the bait compartment to allow access by a targeted rodent and create a rodent path into the receptacle, but not into the substantial enclosure with the trash.

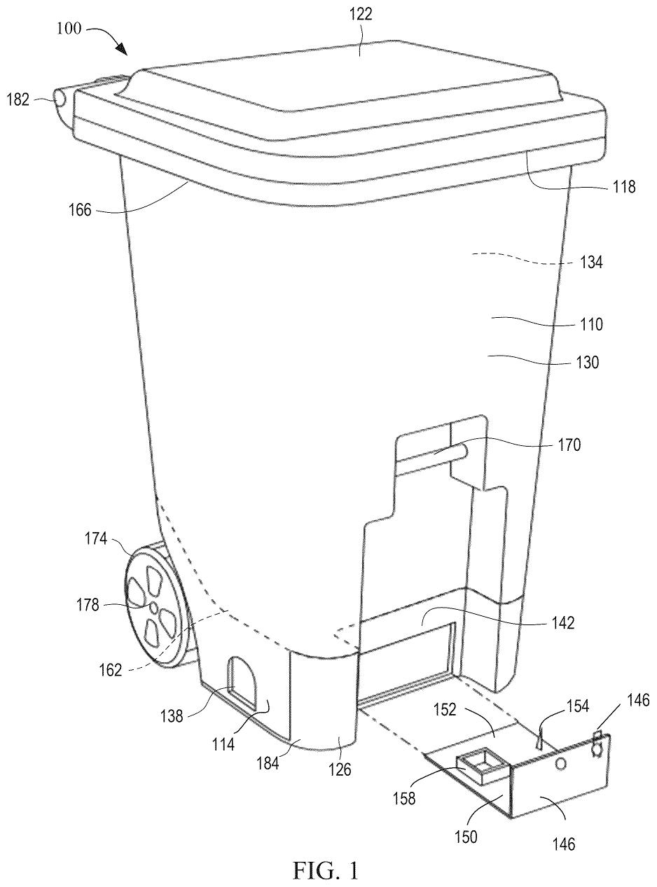

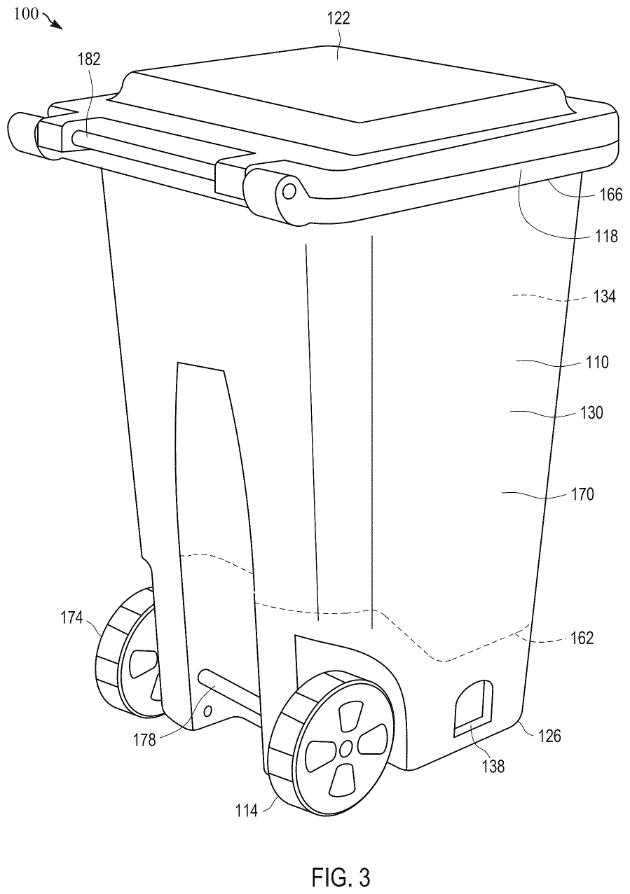

Referring to FIGS. 1-7, an example trash bait station 100 for trash collection with rodent control is shown, according to some embodiments. The description of the trash bait station 100 is applicable to all embodiments described herein. The trash bait station 100 can comprise a receptacle 110 configured to receive trash and a bait compartment 114 configured to contain a toxic bait.

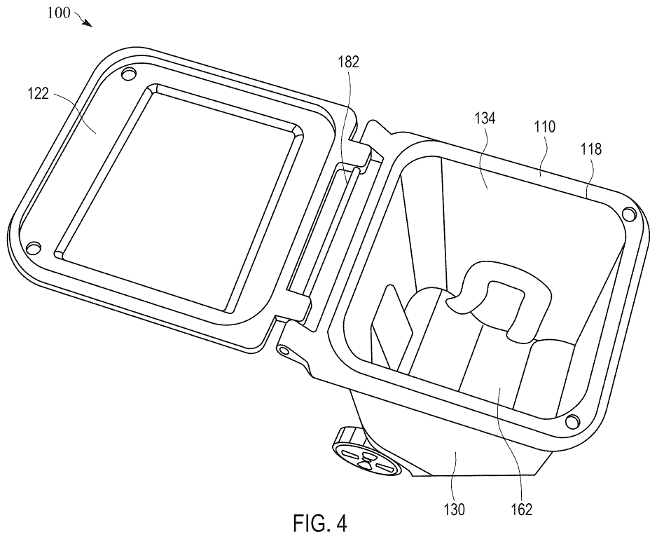

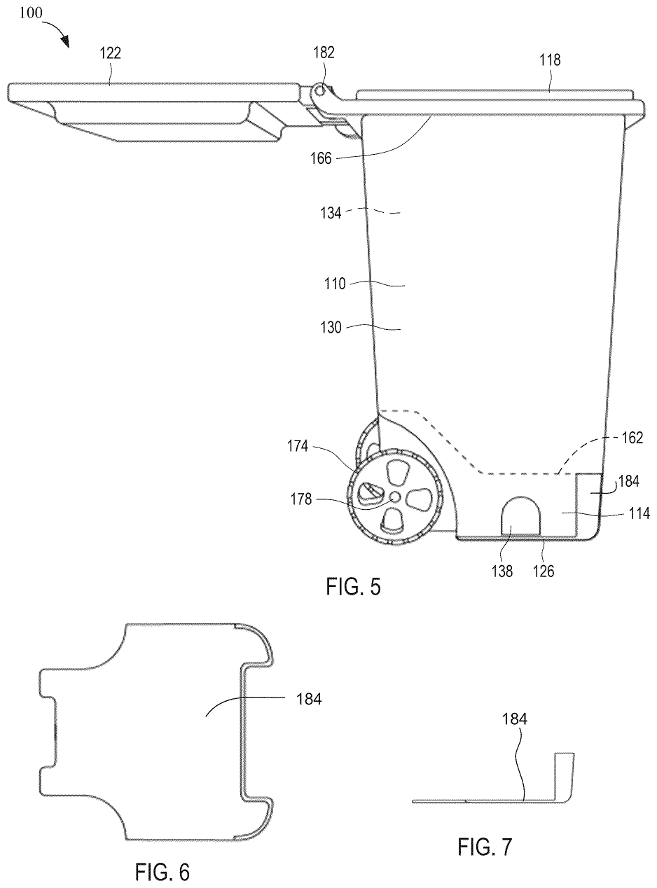

The receptacle 110 can comprise an open top 118 closable by a lid 122. The lid 122 can be pivotal with respect to the receptacle 110 between a closed position (FIGS. 1-3) covering the open top 118 and an open position (FIGS. 4 and 5) configured to receive and release trash through the open top 118. The receptacle 110 can also comprise a bottom 126 opposite the open top 118 and a perimeter wall 130 extending between the open top 118 and the bottom 126. The perimeter wall 130 can substantially or completely circumscribe the receptacle 110 and the bait compartment 114. The perimeter wall 130 can be substantially or completely solid and closed. The bottom 126 can span the perimeter wall 130 and close the bottom of the receptacle 110. The bottom 126 can rest on a support surface, such as the ground.

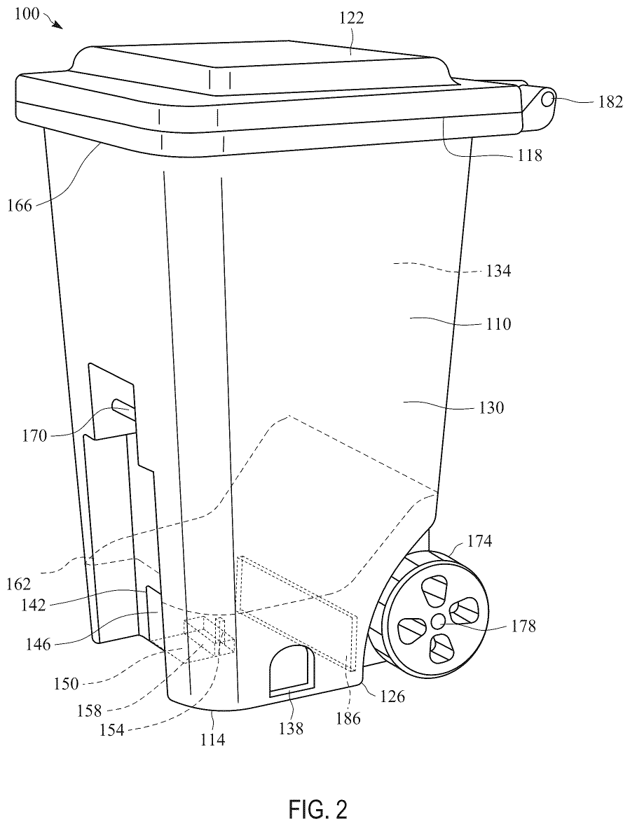

The bait compartment 114 can be associated with the receptacle 110 and configured to receive a toxic bait that is lethal to rodents. The bait compartment 114 can be separate from a substantial enclosure 134 of the receptacle 110 containing the trash. The substantially enclosure 134 can be substantially or completely circumscribed by the perimeter wall 130. A rodent aperture 138 can be formed through the perimeter wall 130 and into the bait compartment 114, and sized to receive a rodent therethrough. The rodent aperture 138 can be located proximate the bottom 126 and the support surface. The rodent aperture 138 can be located in a side or a back of the bait compartment 114 and the receptacle 110. Thus, the rodent aperture 138 can be located where rodents travel, such as the ground. A bait aperture 142 can be formed through the perimeter wall 130 and into the bait compartment 114, and configured to allow insertion of the toxic bait into the bait compartment 114. The bait aperture 142 can be located at a front of the bait compartment 114 and the receptacle 110 for access while baiting. A bait door 146 can be carried by the receptacle 110 and the bait compartment 114 and can selectively close (FIG. 2) and open (FIG. 1) the bait aperture 142.

According to some embodiments, the bait door 146 can further comprise a bait drawer 150 slidably received in the bait aperture 142. The bait drawer 150 or the bait door 146 can further comprise a bait spike 154 or a bait dish 158 configured to receive the toxic bait. The bait spike 154 or the bait dish 158 can assist in retaining the toxic bait in the bait compartment 114. The bait drawer 150 can have a platform 152 coupled to the bait door 146 to carry the bait spike 154 or the bait dish 158, and thus the toxic bait, to facilitate baiting. The platform 152 of the bait drawer 150 can slide on top of the bottom 126 of the receptacle 110 and the bait station 114.

According to some embodiments, the bait door 146 and the bait drawer 150 can have a latch 160 to secure the bait door 146 and the bait drawer 150 to the bait station 114, such as the perimeter wall 130. The latch 160 can be tamper resistant to resist inadvertent opening. For example, the latch 160 can comprise a magnetic lock with a ferromagnetic material (e.g. a material with iron or a magnet) that can be acted upon by a magnet from outside the bait door 146 to release the latch 160. The latch 160 can have a member that pivots into and out of engagement with the perimeter wall 130, or a spring loaded member that slides into engagement with the perimeter wall 130 by a spring.

In one aspect, the toxic bait may comprise bromethalin, cholecalciferol, zinc phosphide, and strychnine.

The receptacle 110 can have a partition wall 162 in the receptacle 110 separating the bait compartment 114 from the substantial enclosure 134. The partition wall 162 can form the substantial enclosure 134 with the perimeter wall 130 to contain the trash. The partition wall 162 can be a bottom wall of the substantial enclosure 134, opposite the open top 118, and forming the substantial enclosure 134 with the perimeter wall 130. The partition wall 162 can separate the bait compartment 114, and thus the toxic bait, from the substantial enclosure 134. Thus, the partition wall 162 can divide an interior of the receptacle 110 into the substantial enclosure 134 for the trash and an interior of the bait compartment 114 with the toxic bait. The partition wall 162 can be solid and continuous to resist rodents from chewing an opening from the bait compartment 114 into the substantial enclosure 134, and thus the trash. The bait compartment 114 can be substantially sealed with respect to the substantial enclosure 134 to resist undesired displacement/control of the toxic bait and distraction from the toxic bait by the trash. The partition wall 162 can be a closed bottom wall and the substantial enclosure 134 can comprise the closed bottom wall. The bait compartment 114 can be separated from the substantial enclosure 134 by the closed bottom wall.

According to some embodiments, the trash bait station 100 and the receptacle 110 can be a residential trash bin of the type distributed by municipalities, placed curbside, and emptied by garbage trucks with articulated arms. Thus, the receptacle 110 and the substantial enclosure 134 of the receptacle can have a volume greater than 90 gallons to be suitable for residential curbside service. The receptacle 110 can comprise a ridge 166 in an outer perimeter wall configured to be engaged by an articulated lift mechanism or a rod 170 in the front configured to be engaged by a hook. Thus, the trash bait station 100 can be suitable for mechanized garbage truck service.

The trash bait station 100 and the receptacle 110 can comprise a pair of wheels 174 associated with the receptacle 110 and rotatable about an axle 178. The pair of wheels 174 can have a size and the axle 178 can be positioned with respect to the receptacle 110 so that receptacle 110 rests with the bottom 126 on the support surface. For example, the axle 178 can be located near a rear of the receptacle 110. As another example, the pair of wheels 174 can have a size or a radius to extend to the support surface with the bottom 126 resting on the support surface. The receptacle 110 can be pivotal about the axle 178 of the pair of wheels 174 between a standing configuration with the bottom 126 on the support surface and a rolling configuration with the receptacle 110 tilted onto the pair of wheels 174.

The pair of wheels 174 can be recessed into a pair of opposite indentations in the perimeter wall 130 to protect the wheels. According to some embodiments, the partition wall 162 can have a substantially horizontal portion (when the receptacle 110 is in the standing configuration) and a deflected portion that can be curved and/or inclined to accommodate the pair of opposite indentations for the pair of wheels 174. According to some embodiments, the partition wall 162 can be substantially or completely flat and horizontal (when the receptacle 110 is in the standing configuration), and can extend from a front of the receptacle 110 to the pair of opposite indentations for the pair of wheels 174, rather than over the pair of opposite indentations, and to a rear of the receptacle 110.

A handle 182 can be associated with the receptacle 110 and configured to pivot the receptacle 110 between the standing and rolling configurations. The handle 182 can also form a pivot for the lid 122 and the lid 122 can pivot about the handle 182.

According to some embodiments, the substantial enclosure 134 and the bait compartment 114 can comprise a common perimeter wall 130. In addition, the common perimeter wall 130 and the partition wall 162 can be integrally formed together as a single, monolithic structure. Thus, the receptacle 110 and the bait compartment 114 can be formed together as a single unit and in a single process to save time and cost of manufacture. In one aspect, the bottom 126 can be a separate bottom 184 (FIGS. 6 and 7) and can be formed separately from the rest of the receptacle 110 and joined to the rest of the receptacle 110 (such as with adhesive or heat welding). The separate bottom 184 can have a horizontal portion forming the bottom 126 of the receptacle 110 and a front vertical portion forming a portion of the perimeter wall 130 of the bait station 114 with the bait opening 142. In another aspect, the horizontal portion of the separate bottom 184 can be substantially contained within the perimeter wall 130 so that the perimeter wall 130 of the rest of the receptacle 110 can bear loads and/or impacts. In another aspect, the horizontal portion of the separate bottom 184 can be located under the perimeter wall 130 so that the separate bottom 184 can provide a continuous bottom surface. In another aspect, the separate bottom 184 can carry the support walls 186. In another aspect, the receptacle 110 and the bait compartment 114 can be formed of plastic, such as polyethylene (PE), and can be formed by molding, such as rotational molding.

According to some embodiments, the bait compartment 114 can further comprise support walls 186 intermediate the perimeter wall 130 and extending from the bottom 126 to the partition wall 162 or the bottom wall of the substantial enclosure 134. The support walls 186 can provide support to the partition wall 162 and the bottom wall to support the weight of trash in the substantial enclosure 134.

According to some embodiments, the trash bait station 100 can have a passage extending from the bait compartment 114 to a rear of the receptacle 110 (such as one of the pair of opposite indentations for the pair of wheels 174). The passage can have an inverted U-shape that extends above the partition wall 162. The passage can provide a vent for the bait station 114 and/or an alternative entrance for a rodent to the bait station 114.

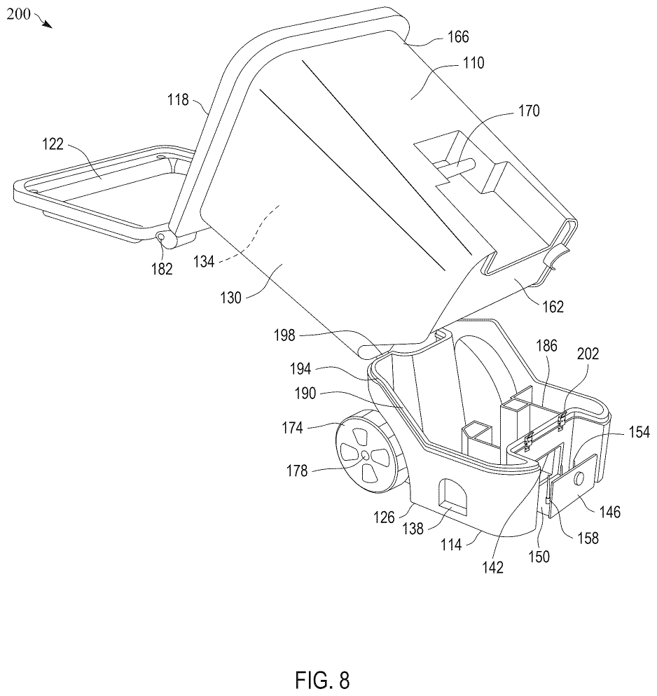

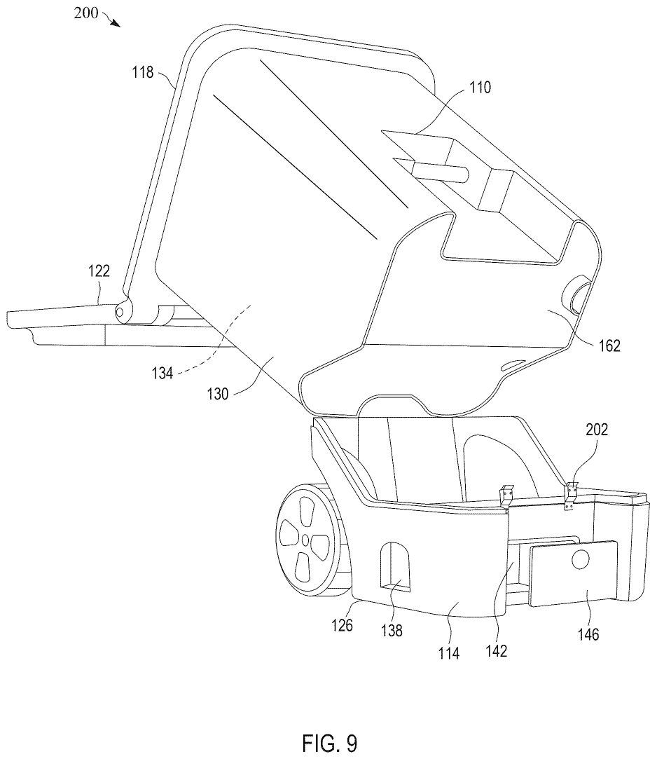

Referring to FIGS. 8 and 9, another example trash bait station 200 for trash collection with rodent control is shown, according to some embodiments. The description of the trash bait station 200 is applicable to all embodiments described herein. According to some embodiments, the bait compartment 114 can form a base 190 carrying the substantial enclosure 134. The bait compartment 114 and the base 190 can have an open top 194 closable by the substantial enclosure 134. The bait compartment 114 and the substantial enclosure 134 can be movably coupled together. For example, the substantial enclosure 134 and the bait compartment 114 can be pivotally coupled together by one or more hinges 198 on one side, and secured by one or more latches 202 on another side. The substantial enclosure 134 and a top portion of the receptacle can move or pivot between a closed position selectively closing the open top 194 of the bait compartment 114, and an open position exposing the open top 194 of the bait compartment 114. This can provide access to the bait compartment for cleaning and maintenance.

Reference throughout this specification to “an example” or “exemplary” means that a particular feature, structure, or characteristic described in connection with the example is included in at least one embodiment of the present invention. Thus, appearances of the phrases “in an example” or the word “exemplary” in various places throughout this specification are not necessarily all referring to the same embodiment.

As used herein, a plurality of items, structural elements, compositional elements, and/or materials can be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention can be referred to herein along with alternatives for the various components thereof. It is understood that such embodiments, examples, and alternatives are not to be construed as defacto equivalents of one another, but are to be considered as separate and autonomous representations of the present invention.

Furthermore, the described features, structures, or characteristics can be combined in any suitable manner in one or more embodiments. In the following description, numerous specific details are provided, such as examples of layouts, distances, network examples, etc., to provide a thorough understanding of embodiments of the invention. One skilled in the relevant art will recognize, however, that the invention can be practiced without one or more of the specific details, or with other methods, components, layouts, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A trash bait station, comprising:
a receptacle configured to receive trash, the receptacle comprising an open top closable by a lid, a bottom opposite the open top and a perimeter wall;
a bait compartment associated with the receptacle and configured to receive a toxic bait that is lethal to rodents;
a rodent aperture through the perimeter wall and into the bait compartment sized to receive a rodent therethrough;
a bait aperture through the perimeter wall and into the bait compartment configured to allow insertion of the toxic bait into the bait compartment;
a bait door carried by the bait compartment and selectively closing the bait aperture; and
a partition wall in the receptacle forming a substantial enclosure with the perimeter wall configured to contain the trash, and the partition wall separating the bait compartment from the substantial enclosure.

2. The trash bait station of claim 1, wherein:
the partition wall is solid and continuous; and
the bait compartment is substantially sealed with respect to the substantial enclosure.

3. The trash bait station of claim 1, further comprising:
the rodent aperture being located proximate to the bottom.

4. The trash bait station of claim 1, further comprising:
the lid being pivotal with respect to the receptacle between a closed position covering the open top and an open position configured to receive and release trash through the open top;
a pair of wheels associated with the receptacle and rotatable about an axle with the pair of wheels having a size and the axle being positioned with respect to the receptacle so that receptacle rests with the bottom on a support surface;
the receptacle being pivotal about the axle of the pair of wheels between a standing configuration with the bottom on the support surface and a rolling configuration with the receptacle tilted onto the pair of wheels; and
a handle associated with the receptacle and configured to pivot the receptacle between the standing and rolling configurations.

5. The trash bait station of claim 4, further comprising:
the substantial enclosure having a volume greater than 90 gallons; and
the receptacle comprising a ridge in an outer perimeter wall configured to be engaged by an articulated lift mechanism or a rod in a front configured to be engaged by a hook.

6. The trash bait station of claim 1, wherein:
the substantial enclosure and the bait compartment comprise a common perimeter wall; and
the common perimeter wall and the partition wall are integrally formed together as a single, monolithic structure.

7. The trash bait station of claim 1, wherein:
the bait door further comprises a bait drawer slidably received in the bait aperture; and
the bait drawer further comprises a bait spike or a bait dish configured to receive the toxic bait.

8. The trash bait station of claim 1, further comprising:
the bait compartment forming a base carrying the substantial enclosure;
the bait compartment having an open top closable by the substantial enclosure; and
the bait compartment and the substantial enclosure being movably coupled together.

9. A trash bait station, comprising:
a receptacle configured to receive trash, the receptacle comprising an open top closable by a lid, a bottom wall opposite the open top and a perimeter wall forming a substantial enclosure configured to receive trash;
a bait compartment associated with the receptacle and separate from the substantial enclosure, the bait compartment configured to receive a toxic bait that is lethal to rodents;
a rodent aperture in the bait compartment sized to receive a rodent therethrough;
a bait aperture in the bait compartment configured to allow insertion of the toxic bait into the bait compartment; and
a bait door carried by the bait compartment and selectively closing the bait aperture.

10. The trash bait station of claim 9, wherein:
the substantial enclosure comprises a closed bottom wall; and
the bait compartment is separated from the substantial enclosure by the closed bottom wall.

11. The trash bait station of claim 9, further comprising:
the rodent aperture being located proximate to a bottom of the receptacle.

12. The trash bait station of claim 9, further comprising:
the lid being pivotal with respect to the receptacle between a closed position covering the open top and an open position configured to receive and release trash through the open top;
a bottom associated with the receptacle and resting on a support surface;
a pair of wheels associated with the receptacle and rotatable about an axle with the pair of wheels being sized and the axle being positioned with respect to the receptacle with the bottom of the receptacle resting on the support surface;
the receptacle pivotal about the axle of the pair of wheels between a standing configuration with the bottom on the support surface and a rolling configuration with the receptacle tilted onto the pair of wheels; and
a handle associated with the receptacle and configured to pivot the receptacle between the standing and rolling configurations.

13. The trash bait station of claim 12, further comprising:
the substantial enclosure having a volume greater than 90 gallons; and
the receptacle comprising a ridge in an outer perimeter wall configured to be engaged by an articulated lift mechanism or a rod in a front configured to be engaged by a hook.

14. The trash bait station of claim 9, wherein:
the substantial enclosure and the bait compartment comprise a common perimeter wall; and
the common perimeter wall and the bottom wall are integrally formed together as a single, monolithic structure.

15. The trash bait station of claim 9, wherein:
the bait door further comprises a bait drawer slidably received in the bait aperture; and
the bait drawer further comprises a bait spike or a bait dish configured to receive the toxic bait.

16. The trash bait station of claim 9, further comprising:
the bait compartment forming a base carrying the substantial enclosure;
the bait compartment having an open top closable by the substantial enclosure; and
the bait compartment and the substantial enclosure being movably coupled together.

17. A trash bait station, comprising:
a receptacle configured to receive trash, the receptacle comprising an open top closable by a lid, a bottom opposite the open top and a perimeter wall;
the lid being pivotal with respect to the receptacle between a closed position covering the open top and an open position configured to receive and release trash through the open top;
a pair of wheels associated with the receptacle and rotatable about an axle with the pair of wheels having a size and the axle being positioned with respect to the receptacle so that receptacle rests with the bottom on a support surface;
the receptacle pivotal about the axle of the pair of wheels between a standing configuration with the bottom on the support surface and a rolling configuration with the receptacle tilted onto the pair of wheels;
a handle associated with the receptacle and configured to pivot the receptacle between the standing and rolling configurations;
a bait compartment associated with the receptacle and configured to receive a toxic bait that is lethal to rodents;
a rodent aperture in the bait compartment sized to receive a rodent therethrough;
a bait aperture in the bait compartment configured to allow insertion of the toxic bait into the bait compartment;
a bait door carried by the bait compartment and selectively closing the bait aperture; and
a partition wall in the receptacle and forming a substantial enclosure with the perimeter wall configured to contain the trash, and separating the bait compartment from the substantial enclosure.

18. The trash bait station of claim 17, wherein:
the partition wall is solid and continuous; and
the bait compartment is substantially sealed with respect to the substantial enclosure.

19. The trash bait station of claim 17, further comprising:
the rodent aperture being located proximate to the bottom and the support surface.

20. The trash bait station of claim 17, wherein:
the substantial enclosure and the bait compartment comprise a common perimeter wall; and
the common perimeter wall and the partition wall are integrally formed together as a single, monolithic structure.
